(19) United States
(12) Patent Application Publication
(10) Pub. No.: US 2025/0072398 A1
(43) Pub. Date: Mar. 6, 2025

(54) Hands-Free Crossbody Leash with Built-In Waste Bag Dispenser and Defense Pocket includes a crossbody

(71) Applicant: Arlyne Rondon, Saint Johns, FL (US)

(72) Inventor: Arlyne Rondon, Saint Johns, FL (US)

(21) Appl. No.: 18/241,960

(22) Filed: Sep. 4, 2023

(51) Int. Cl. A01K 27/00; A45F 5/00

(52) U.S. Cl. CPC A01K 27/008; A01K 27/003; A45F 5/00; A45F 2005/002; A45F 2005/006

(57) ABSTRACT

The adjustable crossbody utilizes clip-on leashes via swivel bolt snaps to connects to pets to allow restraint without use of hands. At least one clip-on leash can connect to an O-ring on the crossbody to allow one to restrain multiple pets. The crossbody contains a bag dispenser for pet waste and an elastic edge pocket to store defense spray. The crossbody and clip-on leashes utilize a slider allowing them to adjust to the user's need.

### BACKGROUND

This invention utilizes a crossbody with an O-ring and leashes with bolt snaps to allow handsfree use. It also contains pockets and sliders to improve convenience and comfort for the user. This can be beneficial for users with multiple pets to restrain, involved in sports, disabled and for many other reasons.

Provision Patent is 63405456.

Patent US20060266301A1 was an adjustable leash using sliders and offers a hand's free option. This invention offers sliders to adjust both the crossbody and clip-on leashes. It's also a primary hands-free leash, however the clip-on leashes can be removed for handheld use.

Patent U.S. Pat. No. 6,192,835B1 is a handsfree leash that allows for easy connect and disconnect to the user and allows the leash to attach to the belt when not in use for storage purposes. This invention allows quick connect and disconnect to the crossbody utilizing a bolt snap. Both ends of the leash can be connected to the crossbody for easy storage when not in use.

Patent USD713606S1 is an ornamental patent for handsfree use that utilizes bolt snaps on both ends. This invention also utilized bolt snaps at each end of the leash. This was designed to connect to a crossbody instead of a waist belt. Our leash also includes a slider for adjustable lengths.

Patent U.S. Pat. No. 7,938,086B2 is a handsfree leash that utilizes rings and bolt snaps for handsfree function. This invention utilizes a ring to connect the leashes to the crossbody.

### BRIEF SUMMARY

The Hands-Free Crossbody Leash with Built-In Waste Bag Dispenser and Defense Pocket includes a crossbody with a slider for adjustability, a pocket with an elastic opening to hold standard defense sprays, a pocket with a snap button and grommet to dispense bags, and an O-ring to connect at least one clip-on leash. The clip-on leashes have a bolt swivel snap on both ends so it can connect to the crossbody and the dog. It has a slider to adjust leash lengths.

### BRIEF DESCRIPTION OF DRAWINGS

FIG. 1 demonstrates the clip-on leash. It uses 1 inch strap that is 6 feet long. The strap has a slider that allows it to adjust in length. At both ends of the leash there is a bolt snap.

FIG. 2 demonstrates the crossbody. The strap is 2 inches wide and 58 inches in length. Both ends of the strap connect to an O-ring. There is a slider on the strap to allow user to adjust size. There are two pockets, the lower one is 4.5 inches tall with an elastic opening. The second pocket is 4 inches tall. It has a snap button on the top and a grommet at the center.

### DETAILED DESCRIPTION

The following disclosure may be implemented in a variety of ways. The figures and detailed description below describe one embodiment of the disclosure for illustrative purposes. However, the disclosure is not limited to this embodiment, and other embodiments may be possible.

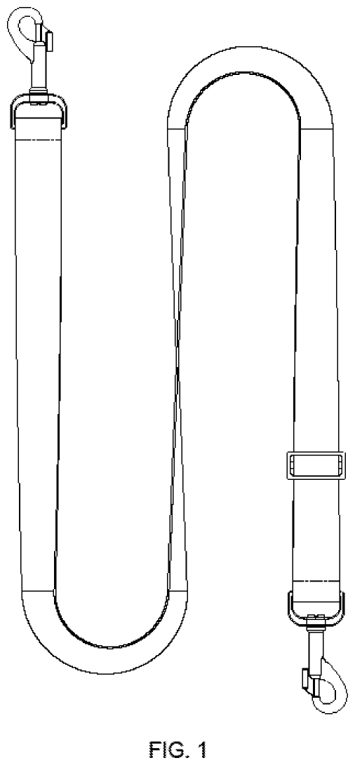

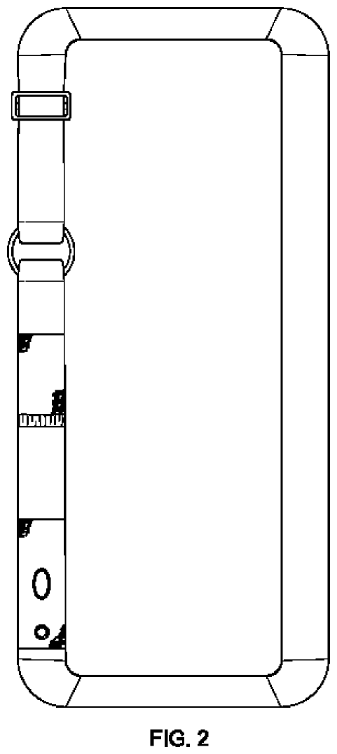

FIG. 1: This represents the leash that connects to the Crossbody (FIG. 2) strap. It has a swivel bolt snap on each end of the leash. The bolt snaps are used to attach to the O-ring on the Crossbody (FIG. 2) leash to restrain the dog. The leash has a slider at the top, to adjust the length of the leash to allow it to be used as a hand leash, when you adjust the slider to fit the hand. It is sturdy in construction and built to hold dogs of various sizes. Both ends can be connected to the O-ring on the crossbody (FIG. 2) for storage purposes. The material is a polyester canvas.

The leash is constructed from a 1-inch canvas strap that is 6 feet long. On one end a bolt snap is sewn into the strap. The other end had the bolt snap attached via a loop created after the slider was added and sewn in. Once completed the leash can be adjusted from 3 feet to 5.5 feet in length.

FIG. 2: This represents the crossbody that is worn by the user. It is worn across the body and can be used on the left and right side of the user. The crossbody has a central O-ring that is worn in the lowest position. This O-ring allows the leash (FIG. 1) to connect to the crossbody for pet restraint or storage purposes. On the front end of the crossbody are two pockets as illustrated. The lower pocket is 4.5 inches in height and has an elastic opening. This is designed to hold standard defense sprays. The pocket above is a 4-inch pocket with a snap button at its opening and a grommet in the center. This allows it to hold standard pet disposal bags. At the back of the crossbody is a slider to allow users to adjust sizing.

The crossbody is from a 2-inch polyester canvas strap that is 58 inches in length. On end is sewn into the O-ring that has a 60 mm interior diameter. The other end is looped through the O-ring and sewn into a slider. Both pockets were sewn into a crossbody.

1. A hands-free leash comprising:
a crossbody strap;
a O-ring;
a defense pocket;
a bag dispenser;
and at least one of the adjustable clip-on leashes.
The O-ring is attached to the crossbody strap.
The defense pocket is attached to the crossbody strap.
The bag dispenser is attached to the crossbody strap.
At least one of the adjustable clip-on leashes are attached to the crossbody.
The crossbody is adjustable in length.
The clip-on leashes are adjustable in length.
The defense pocket is configured to store a defense spray.
The bag dispenser is configured to dispense bags for dog waste.
At least one of the adjustable clip-on leashes is configured to be attached to different objects, such as apparel or furniture.
